(19) United States
(12) Patent Application Publication
(10) Pub. No.: US 2010/0270787 A1
(43) Pub. Date: Oct. 28, 2010

(54) Food diary on keychain

(76) Inventor: Roseann Benney, (US)

Correspondence Address: Roseann Benney, 137 Leonardine Ave., South River, NJ, 08882, US

(21) Appl. No.: 12/386,784

(22) Filed: Apr. 23, 2009

(51) Int. Cl. B42D 3/00; A44B 15/00; G09B 19/08; B42D 15/00

(52) U.S. Cl. 281/29; 24/3.6; 283/45; 283/64

(57) ABSTRACT

A food diary or journal small enough to fit comfortably on a keyring and meant to be carried with one's keys. Attaching the food journal to a keychain makes it easier to find in a pocketbook and also decreases the chances of the food journal being lost or left at home. The journal consists of bound covered paper with a single hole in the upper left corner to allow for insertion of a keyring. The pages of the journal may or may not be preprinted to allow conformation to a specific diet. The cover of the journal may contain a logo, design, or any type of artwork. Inspirational charms may also be added to the food diary keychain combination.

### CROSS-REFERENCE TO RELATED APPLICATION

Not Applicable

### BACKGROUND OF THE INVENTION

Self-monitoring of one's food intake is known to be important for weight loss. Keeping a food diary, also known as a food journal, has commonly been used as a tool to assist in the self-monitoring of food intake. A food diary is also a useful tool for some people with chronic illnesses such as diabetes.

Food diaries are usually kept on pieces of paper or small notebooks. Journaling in this fashion has some drawbacks. A lot of times the paper ends up crumbled on the bottom of a woman's pocketbook or man's pocket. Food journaling requires the journal to be taken in and out of a pocketbook or pocket many times during the day. Thus the journal can be easily torn, crumbled, misplaced, lost, or just forgotten at home. A notebook journal is not as portable, can be awkward, and also can be easily misplaced or forgotten at home.

### BRIEF SUMMARY OF THE INVENTION

The combination of a food journal and a keychain solves the above problems. Downsizing of the food journal to a smaller size and placing it on a keychain to be carried with a set of keys makes the food journal more portable and easier to find. An advantage to having your food journal with your keys is that you are less likely to forget your keys when you leave home than you would your food journal. Now instead of remembering both your keys and your food journal when you leave home, you only need to remember your keys. If you remember your keys, you have automatically remembered your food journal.

In general people are more conscientious about the location or placement of their keys than the location or placement of a food journal. Thus the likelihood of losing your food journal is lessened when it is attached to your keys. Having a food journal attached to your keys also makes it easier to find the food journal in a pocketbook. Instead of rummaging through a pocketbook for pieces of paper that are being used as a food journal, you need only find your keys and your journal is attached.

Also, inspirational charms may be added to the keychain food journal combination as a helpful reminder to stick to a weight loss plan.

### DESCRIPTION OF THE DRAWINGS

FIG. 1 is a drawing of small pieces of paper with a hole punched in the upper left corner for insertion of a keyring.

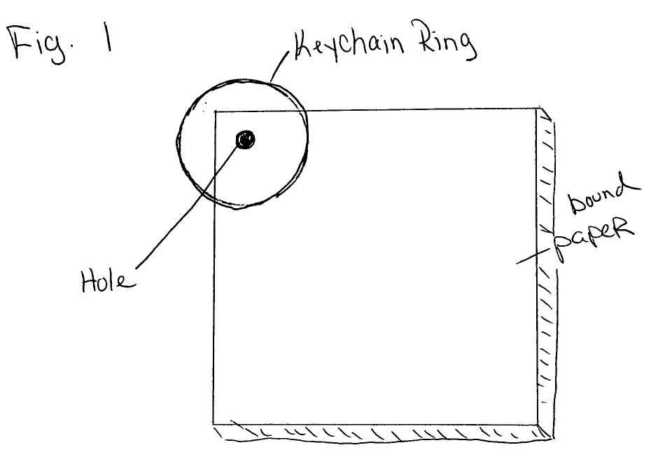

FIG. 2 is a drawing of a cover to which the pieces of paper are bound. The cover is made of thicker paper and surrounds all of the paper except for the upper left corner where the paper and keyring hole is left exposed. The cover can be held closed by fabric hook and loop tape, a snap, or by two magnets.

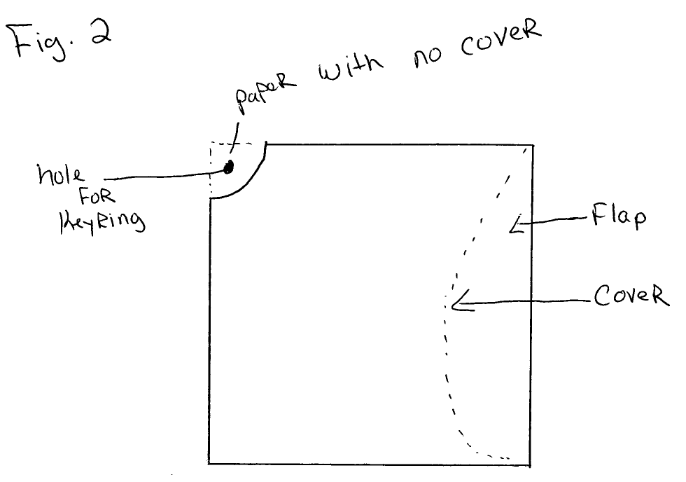

### DETAILED DESCRIPTION OF THE INVENTION

The invention is a food journal small enough to fit on a keyring. The journal consists of paper small enough to be comfortably carried on a keychain and bound together to a cover. The paper has a small hole in the upper left corner for insertion of a keyring. The cover surrounds all of the paper except for the upper left corner which is left exposed for the keyring. The cover may contain any kind of logo, artwork, or design. The keyring may or may not contain inspirational charms to assist injournaling. The journal paper may be printed with spaces for the date and columns for entries of meals, snacks, calories, etc. The paper may also be printed to help a person conform to a specific diet if necessary.

1. A food journal small and portable enough to fit on a keyring consisting of bound paper small enough to be comfortably carried on a keychain with a small hole in the upper left corner for insertion of a keyring; the cover being made of thicker grade paper that surrounds the journal paper entirely except for the upper left corner which is left exposed for the keyring; the cover being held closed by either fabric hook and loop take, a snap, or by a set of small magnets.

2. A keychain food journal according to claim 1 wherein the journal paper is printed with spaces for date entry and columns for recordation of meals, snacks, and calories. The journal paper may also be preprinted to conform to any method for dieting.

3. A keychain food journal according to claim 1 with a cover that contains a logo, artwork, or design.

4. A keychain food journal according to claim 1 with the use of inspirational charms.
